(19) United States
(12) Patent Application Publication
(10) Pub. No.: US 2020/0290599 A1
(43) Pub. Date: Sep. 17, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Junpei Noguchi, Wako-shi (JP); Yasushi Shoda, Wako-shi (JP); Yuki Hara, Wako-shi (JP); Katsuyasu Yamane, Wako-shi (JP); Yoshitaka Mimura, Wako-shi (JP); Hiroshi Yamanaka, Wako-shi (JP); Ryoma Taguchi, Tokyo (JP); Yuta Takada, Tokyo (JP); Chie Sugihara, Tokyo (JP); Yuki Motegi, Tokyo (JP); Tsubasa Shibauchi, Tokyo (JP)

(21) Appl. No.: 16/809,593

(22) Filed: Mar. 5, 2020

(30) Foreign Application Priority Data
Mar. 12, 2019 (JP) 2019-044985

(51) Int. Cl. B60W 30/06; B60W 10/04; B60W 10/20; G06Q 10/10; G06Q 50/30; G06Q 50/14

(52) U.S. Cl. CPC B60W 30/06; B60W 10/04; B60W 10/20; G06Q 10/1093; B60Q 3/80; G06Q 50/14; B60W 2720/10; B60W 2710/20; B60W 2540/041; G06Q 50/30

(57) ABSTRACT

A vehicle control system includes a recognizer configured to recognize a surrounding environment of a vehicle, a driving controller configured to perform at least one of speed control and steering control of the vehicle on the basis of a recognition result of the recognizer, and a schedule information acquirer configured to acquire schedule information of a rider of the vehicle, wherein the driving controller is configured to determine an exiting mode for the vehicle letting the rider exit or a boarding mode for the vehicle letting the rider board on the basis of the schedule information acquired by the schedule information acquirer.

### CROSS-REFERENCE TO RELATED APPLICATION

Priority is claimed on Japanese Patent Application No. 2019-044985, filed Mar. 12, 2019, the content of which is incorporated herein by reference.

### BACKGROUND

### Field of the Invention

The present invention relates to a vehicle control system, a vehicle control method, and a storage medium.

### Description of Related Art

A technology regarding driving assistance relating to parking in a parking lot and driving assistance relating to retrieval from a parking lot while a vehicle is traveling is known in the art (for example, Japanese Unexamined Patent Application, First Publication No. 2018-176909).

### SUMMARY

Incidentally, it is desirable that, when a rider exits or boards a vehicle, the vehicle be stopped in a mode in which the rider can easily board and exit according to a behavior of the rider so far and a state of the rider such as a schedule that is to be performed thereafter. However, in the technology of the related art, it is difficult to change the mode of a vehicle when a rider boards and exits the vehicle.

Aspects of the present invention have been made in view of such circumstances and it is an object of the present invention to provide a vehicle control system, a vehicle control method, and a storage medium that can control a vehicle according to the state of a rider such that the rider can easily board and exit the vehicle.

A vehicle control system, a vehicle control method, and a storage medium according to the present invention employ the following configurations.

(1A vehicle control system according to an aspect of the present invention includes a recognizer configured to recognize a surrounding environment of a vehicle, and a driving controller configured to perform at least one of speed control and steering control of the vehicle on the basis of a recognition result of the recognizer, and a schedule information acquirer configured to acquire schedule information of a rider of the vehicle, and wherein the driving controller is configured to determine an exiting mode for the vehicle letting the rider exit or a boarding mode for the vehicle letting the rider board on the basis of the schedule information acquired by the schedule information acquirer.

(2) In the above aspect (1), the schedule information includes an irregular event that is scheduled irregularly, and the driving controller is configured to determine a stop position of the vehicle on the basis of information associated with the irregular event when the irregular event has been scheduled.

(3) In the above aspect (2), the vehicle control system further includes an inquirer configured to inquire, at a time that is a predetermined duration before a pick-up time associated with the irregular event, of the rider whether or not pick-up at the pick-up time is possible and to acquire an inquiry result, and wherein the driving controller is configured to control the vehicle on the basis of the inquiry result acquired by the inquirer.

(4) In the above aspect (1), the schedule information includes a regular event that is scheduled regularly, and wherein the driving controller is configured to determine the boarding mode such that a short time is required until the vehicle departs.

(5) In the above aspect (4), the driving controller is configured to determine the boarding mode such that the rider can board at a pick-up time associated with the regular event even if there is no instruction from the rider.

(6) In any one of the above aspects (1), the schedule information includes the number of riders, and wherein the driving controller is configured to, when the number of riders is larger than a reference, change the boarding mode to a stop position where the riders can easily board compared to when the number of riders is equal to or smaller than the reference and to determine that the exiting mode is a stop position where the riders can easily exit.

(7) In any one of the above aspects (1), the schedule information includes an accommodation place where the rider stays after exiting the vehicle, and wherein the driving controller is configured to, when a pick-up position of the vehicle is a position of the accommodation place, change the boarding mode to a stop position where the rider can easily board or a stop position where the rider can easily load luggage in the vehicle, and determine that the exiting mode is a stop position where the rider can easily exit or a stop position where the rider can easily unload luggage from the vehicle.

(8) In any one of the above aspects (1), the schedule information includes a predetermined day regarding the rider or a predetermined schedule regarding the rider, and the vehicle control system further includes an illumination controller configured to control an illumination provided in the vehicle, and wherein the illumination controller is configured to determine a lighting mode of the illumination when a current day corresponds to the predetermined day or a day of the predetermined schedule.

(9) In the above aspect (8), the schedule information includes a regular event that is scheduled regularly or an irregular event that is scheduled irregularly, and wherein the illumination controller is configured to make the lighting mode of the illumination different when the driving controller performs control relating to the regular event and when the driving controller performs control relating to the irregular event.

(10) In the above aspect (1), the schedule information includes at least one of the number of riders scheduled to board the vehicle, an attribute of the riders of the vehicle, and a destination of the vehicle, and wherein the driving controller is configured to change a boarding mode and an exiting mode on the basis of the number of riders scheduled to board the vehicle, the attribute of the riders of the vehicle, or the destination of the vehicle.

(11) A vehicle control method according to an aspect of the present invention includes a computer recognizing a surrounding environment of a vehicle, and performing at least one of speed control and steering control of the vehicle on the basis of a result of the recognition, and acquiring schedule information of a rider of the vehicle, and determining an exiting mode for the vehicle letting the rider exit or a boarding mode for the vehicle letting the rider board on the basis of the acquired schedule information.

(12) A storage medium according to an aspect of the present invention is a non-transitory computer-readable storage medium storing a program that causes a computer to recognize a surrounding environment of a vehicle, and perform at least one of speed control and steering control of the vehicle on the basis of a result of the recognition, and acquire schedule information of a rider of the vehicle, and determine an exiting mode for the vehicle letting the rider exit or a boarding mode for the vehicle letting the rider board on the basis of the acquired schedule information.

According to the above aspects (1) to (12), it is possible to control the vehicle according to a state of rider such that the rider can easily board and exit the vehicle.

According to the above aspects (2) and (3), it is possible to control the vehicle according to a state of rider on a holiday such that the rider can easily board and exit the vehicle.

According to the above aspects (4) and (5), it is possible to control the vehicle according to a state of rider on a weekday such that the rider can easily board and exit the vehicle.

According to the above aspects (8) and (9), it is possible to clearly inform the rider of his or her schedule.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of a parking environment of an own vehicle.

FIG. 4 is a diagram showing an example of the content of irregular schedule information.

FIG. 5 is a diagram schematically showing a scene in which the own vehicle is stopped in a boarding/exiting mode based on an irregular event in which the number of riders is large.

FIG. 6 is a diagram schematically showing a scene after the own vehicle is stopped on the basis of an irregular event in which the number of riders is large.

FIG. 7 is a diagram schematically showing a scene in which the own vehicle is stopped in a boarding/exiting mode based on an irregular event in which the amount of luggage is large or is assumed to be large.

FIG. 8 is a diagram schematically showing a scene after the own vehicle is stopped on the basis of an irregular event in which the amount of luggage is large or is assumed to be large.

FIG. 9 is a diagram schematically showing a scene in which the own vehicle is stopped in a boarding/exiting mode based on an irregular event in which accommodation is involved.

FIG. 10 is a diagram showing an example of the configuration of a parking lot management device.

FIG. 11 is a diagram showing an example of an execution screen of a notification application executed in a terminal device.

FIG. 12 is a diagram showing an example of the content of regular schedule information.

FIG. 13 is a diagram schematically showing a scene in which the own vehicle is stopped in a boarding/exiting mode based on a regular event in which the number of riders is large.

FIG. 14 is a diagram showing an example of the content of annual schedule information.

FIG. 15 is a flowchart showing a flow of a series of processing for determining a boarding/exiting mode based on an irregular event.

FIG. 16 is a flowchart showing a flow of a series of processing for determining a boarding mode based on a regular event.

FIG. 17 is a flowchart showing a flow of a series of processing for determining a lighting mode of headlights based on an event.

FIG. 18 is a diagram showing an example of the hardware configuration of an automated driving control device according to an embodiment.

### DETAILED DESCRIPTION OF THE INVENTION

Hereinafter, embodiments of a vehicle control device, a vehicle control method, and a storage medium of the present invention will be described with reference to the drawings.

### Overall Configuration

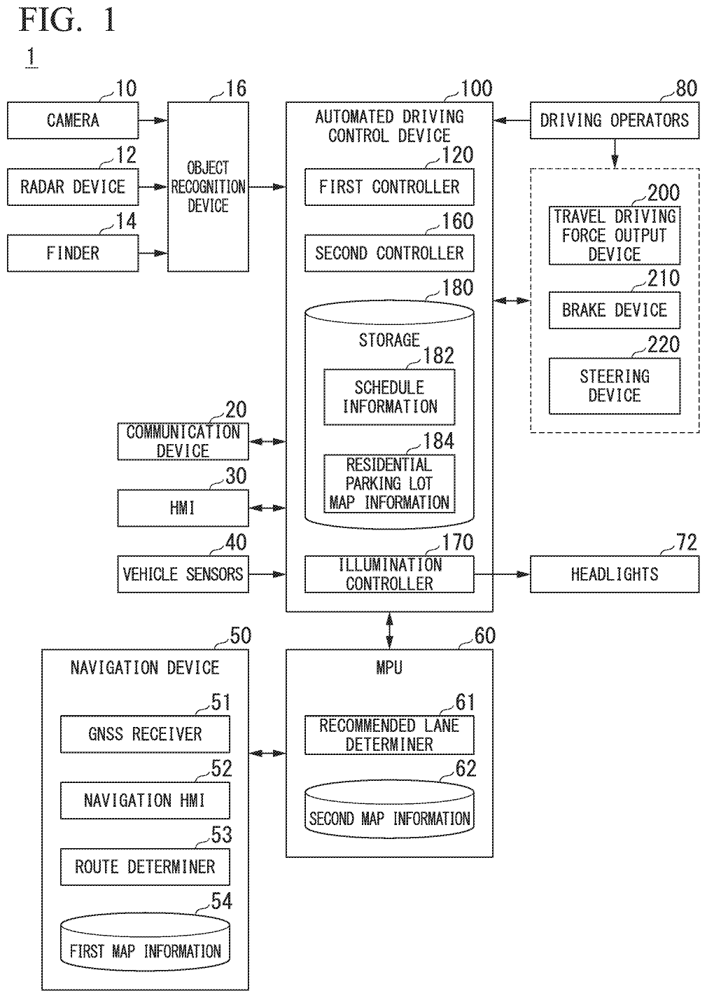

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added.

The camera 10 is, for example, a digital camera using a solid-state imaging device such as a charge coupled device (CCD) or a complementary metal oxide semiconductor (CMOS). The camera 10 is attached to the vehicle in which the vehicle system 1 is mounted (hereinafter referred to as an own vehicle M) at an arbitrary location. For imaging the area in front of the own vehicle M, the camera 10 is attached to an upper portion of a front windshield, a rear surface of a rearview mirror, or the like. For example, the camera 10 repeats imaging of the surroundings of the own vehicle M at regular intervals. The camera 10 may also be a stereo camera.

The radar device 12 radiates radio waves such as millimeter waves around the own vehicle M and detects radio waves reflected by an object (reflected waves) to detect at least the position (distance and orientation) of the object. The radar device 12 is attached to the own vehicle M at an arbitrary location. The radar device 12 may detect the position and velocity of an object using a frequency modulated continuous wave (FM-CW) method.

The finder 14 is a light detection and ranging (LIDAR) finder. The finder 14 illuminates the surroundings of the own vehicle M with light and measures scattered light. The finder 14 detects the distance to a target on the basis of a period of time from when light is emitted to when light is received. The light radiated is, for example, pulsed laser light. The finder 14 is attached to the own vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

For example, the communication device 20 communicates with other vehicles or a parking lot management device (which will be described later) present near the own vehicle M or communicates with various server devices using a cellular network, a Wi-Fi network, Bluetooth (registered trademark), dedicated short range communication (DSRC) or the like.

The HMI 30 presents various types of information to a rider in the own vehicle M and receives an input operation from the rider. The HMI 30 includes various display devices, a speaker, a buzzer, a touch panel, switches, keys, and the like.

The vehicle sensors 40 include a vehicle speed sensor that detects the speed of the own vehicle M, an acceleration sensor that detects the acceleration thereof, a yaw rate sensor that detects an angular speed thereof about the vertical axis, an orientation sensor that detects the orientation of the own vehicle M, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the own vehicle M on the basis of signals received from GNSS satellites. The position of the own vehicle M may also be identified or supplemented by an inertial navigation system (INS) using the output of the vehicle sensors 40. The navigation HMI 52 includes a display device, a speaker, a touch panel, a key, or the like. The navigation HMI 52 may be partly or wholly shared with the HMI 30 described above. For example, the route determiner 53 determines a route from the position of the own vehicle M identified by the GNSS receiver 51 (or an arbitrary input position) to a destination input by the rider (hereinafter referred to as an on-map route) using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60. The navigation device 50 may also perform route guidance using the navigation HMI 52 on the basis of the on-map route. The navigation device 50 may be realized, for example, by a function of a terminal device such as a smartphone or a tablet possessed by the rider. The navigation device 50 may also transmit the current position and the destination to a navigation server via the communication device 20 and acquire a route equivalent to the on-map route from the navigation server.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the own vehicle M can travel on a reasonable route for proceeding to the branch destination.

The second map information 62 is map information with higher accuracy than the first map information 54. The second map information 62 includes, for example, information of the centers of lanes or information of the boundaries of lanes. The second map information 62 may also include road information, traffic regulation information, address information (addresses/postal codes), facility information, telephone number information, or the like. The second map information 62 may be updated as needed by the communication device 20 communicating with another device.

Headlights 70 are lit to emit light in front of the own vehicle M. Lighting and blinking of the headlights 70 is controlled by the automated driving control device 100.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120, a second controller 160, an illumination controller 170, and a storage 180. Each of the first controller 120 and the second controller 160 is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in advance in a storage device (a storage device having a non-transitory storage medium) such as an HDD or a flash memory of the automated driving control device 100 or may be stored in a detachable storage medium such as a DVD or a CD-ROM and then installed in the HDD or flash memory of the automated driving control device 100 by mounting the storage medium (the non-transitory storage medium) in a drive device. The storage 180 stores schedule information 182 and residential parking lot map information 184. Details of the schedule information 182 and the residential parking lot map information 184 will be described later.

The illumination controller 170 and the storage 180 may be realized by a device separated from the automated driving control device 100. For example, the illumination controller 170 and the storage 180 may be realized by an electronic controller (ECU) that controls illumination of the vehicle.

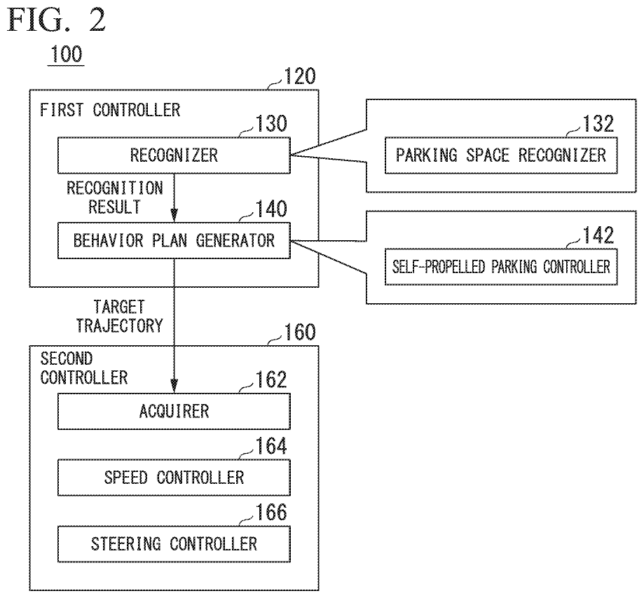

FIG. 2 is a functional configuration diagram of the first controller 120 and the second controller 160. The first controller 120 includes, for example, a recognizer 130 and a behavior plan generator 140. For example, the first controller 120 realizes a function based on artificial intelligence (AI) and a function based on a previously given model in parallel. For example, the function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving.

The recognizer 130 recognizes states such as the position, speed and acceleration of each object present near the own vehicle M on the basis of information input from the camera 10, the radar device 12, and the finder 14 via the object recognition device 16. The position of the object is recognized, for example, as a position in an absolute coordinate system whose origin is at a representative point on the own vehicle M (such as the center of gravity or the center of a drive shaft thereof), and used for control. The position of the object may be represented by a representative point on the object such as the center of gravity or a corner thereof or may be represented by an expressed region. The “states” of the object may include an acceleration or jerk of the object or a “behavior state” thereof (for example, whether or not the object is changing or is going to change lanes).

The recognizer 130 recognizes, for example, a lane in which the own vehicle M is traveling (a travel lane). For example, the recognizer 130 recognizes the travel lane, for example, by comparing a pattern of road lane lines (for example, an arrangement of solid and broken lines) obtained from the second map information 62 with a pattern of road lane lines near the own vehicle M recognized from an image captured by the camera 10. The recognizer 130 may recognize the travel lane by recognizing travel boundaries (road boundaries) including road lane lines, road shoulders, curbs, a median strip, guardrails, or the like, without being limited to road lane lines. This recognition may be performed taking into consideration a position of the own vehicle M acquired from the navigation device 50 or a result of processing by the INS. The recognizer 130 recognizes temporary stop lines, obstacles, red lights, toll gates, and other road phenomena.

When recognizing the travel lane, the recognizer 130 recognizes the position or attitude of the own vehicle M with respect to the travel lane. For example, the recognizer 130 may recognize both a deviation from the lane center of the reference point of the own vehicle M and an angle formed by the travel direction of the own vehicle M relative to an extension line of the lane center as the relative position and attitude of the own vehicle M with respect to the travel lane. Alternatively, the recognizer 130 may recognize the position of the reference point of the own vehicle M with respect to one of the sides of the travel lane (a road lane line or a road boundary) or the like as the relative position of the own vehicle M with respect to the travel lane.

The recognizer 130 includes a parking space recognizer 132 that is activated in a self-propelled parking event that will be described later. Details of the functions of the parking space recognizer 132 will be described later.

The behavior plan generator 140 generates a target trajectory along which the own vehicle M will travel in the future automatically (independently of the driver's operation) such that the own vehicle M basically travels in the recommended lane determined by the recommended lane determiner 61 and further copes with situations occurring near the own vehicle M. The target trajectory includes, for example, a speed element. The target trajectory is expressed, for example, by an arrangement of points (trajectory points) which are to be reached by the own vehicle M in order. The trajectory points are points to be reached by the own vehicle M at intervals of a predetermined travel distance (for example, at intervals of about several meters) along the road. Apart from this, a target speed and a target acceleration for each predetermined sampling time (for example, every several tenths of a second) are generated as part of the target trajectory. The trajectory points may be respective positions at the predetermined sampling times which the own vehicle M is to reach at the corresponding sampling times. In this case, information on the target speed or the target acceleration is represented with the interval between the trajectory points.

When generating the target trajectory, the behavior plan generator 140 may set an automated driving event. Examples of the automated driving event include a constant-speed travel event, a low-speed following travel event, a lane change event, a branching event, a merging event, a takeover event, and a self-propelled parking event that is an event of performing parking by automated driving. The behavior plan generator 140 generates a target trajectory according to an activated event. The behavior plan generator 140 includes a self-propelled parking controller 142 that is activated when a self-propelled parking event is performed. Details of the functions of the self-propelled parking controller 142 will be described later.

The second controller 160 controls the travel driving force output device 200, the brake device 210, and the steering device 220 such that the own vehicle M passes through the target trajectory generated by the behavior plan generator 140 at scheduled times.

Returning to FIG. 2, the second controller 160 includes, for example, an acquirer 162, a speed controller 164, and a steering controller 166. The acquirer 162 acquires information on the target trajectory (trajectory points) generated by the behavior plan generator 140 and stores it in memory (not shown). The speed controller 164 controls the travel driving force output device 200 or the brake device 210 on the basis of a speed element pertaining to the target trajectory stored in the memory. The steering controller 166 controls the steering device 220 according to the degree of bending of the target trajectory stored in the memory. The processing of the speed controller 164 and the steering controller 166 is realized, for example, by a combination of feedforward control and feedback control. As an example, the steering controller 166 performs feedforward control according to the curvature of the road ahead of the own vehicle M and feedback control based on deviation from the target trajectory in combination. A combination of the behavior plan generator 140 and the second controller 160 is an example of the “driving controller.”

The illumination controller 170 controls the lighting mode of the headlights 70 on the basis of a control state of the own vehicle M controlled by the self-propelled parking controller 142.

The travel driving force output device 200 outputs a travel driving force (torque) required for the vehicle to travel to driving wheels. The travel driving force output device 200 includes, for example, a combination of an internal combustion engine, an electric motor, a transmission, and the like and an electronic controller (ECU) that controls them. The ECU controls the above constituent elements according to information input from the second controller 160 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of steering wheels. The steering ECU drives the electric motor according to information input from the second controller 160 or information input from the driving operators 80 to change the direction of the steering wheels.

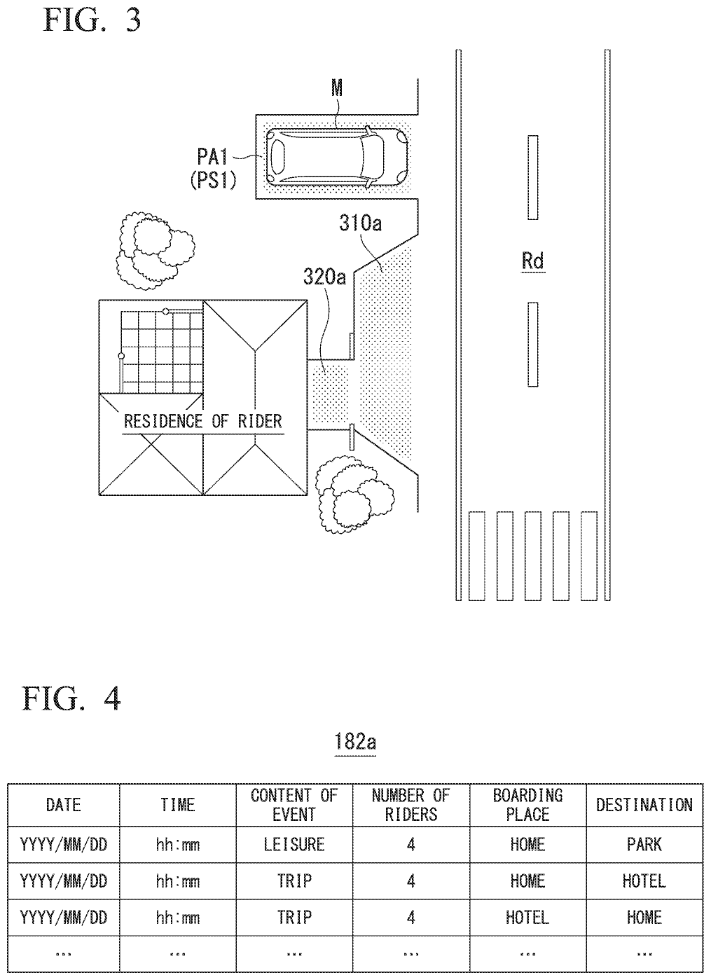

FIG. 3 is a diagram showing an example of a parking environment of an own vehicle M. A parking lot PA1 and a stop area 310a that face a road Rd are provided at a residence of a rider of the own vehicle M. The stop area 310a faces a boarding/exiting area 320a connected to the residence of the rider of the own vehicle M.

### Self-Propelled Parking Event—at the Time of Vehicle Storage

Upon returning to the residence from an outing, the own vehicle M moves to the vicinity of the stop area 310a by manual driving or automated driving based on another functional unit and then starts a self-propelled parking event. A start trigger of the self-propelled parking event relating to vehicle storage may be, for example, an operation performed by the rider or may be a position of the own vehicle M identified by the GNSS receiver 51 that indicates that the own vehicle M has moved to the vicinity of the stop area 310a or the vicinity of a destination registered in the navigation device 50. In the self-propelled parking event, the self-propelled parking controller 142 generates a target trajectory such that the own vehicle M is stopped in the stop area 310a according to an exiting mode based on schedule information 182. After stopping the own vehicle M in the stop area 310a and letting the rider exit, the self-propelled parking controller 142 performs automated driving (self-propelled driving) and generates a target trajectory for moving to a parking space PS1 in the parking lot PA1 on the basis of residential parking lot map information 184. When approaching the target parking space PS1, the parking space recognizer 132 recognizes a parking frame line or the like defining the parking space PS11 to recognize a detailed position of the parking space PS1 and provides the recognized detailed position of the parking space PS1 to the self-propelled parking controller 142. Upon receiving this, the self-propelled parking controller 142 corrects the target trajectory and causes the own vehicle M to be parked in the parking space PS1.

The residential parking lot map information 184 is local map information indicating the positions (or coordinates) of the parking lot PA1, the stop area 310a, and the boarding/exiting area 320a. Residential parking lot map information is derived, for example, from a route or the like that repeatedly appears in a travel history of the own vehicle M and is determined as the residential parking lot map information 184 after confirmation of the rider. The residential parking lot map information 184 may be determined by presenting an image based on the first map information 54 or the second map information 62 and receiving designation of a position by the rider.

The parking lot PA1 does not need to face the road Rd. In this case, the residential parking lot map information 184 or the first map information 54 includes information indicating a route from the parking lot PA1 to the stop area 310a.

### Self-Propelled Parking Event—at the Time of Vehicle Retrieval

The self-propelled parking controller 142 remains in operation while the own vehicle M is parked. For example, based on the schedule information 182, the self-propelled parking controller 142 activates the system of the own vehicle M to start moving to the stop area 310a. The schedule information 182 is information indicating a schedule in which the rider of the own vehicle M is to board the own vehicle M to move. For example, the schedule information 182 may be provided to the vehicle system 1 from the terminal device TM possessed by the rider of the own vehicle M via a network or may be provided to the vehicle system 1 via short-range wireless communication (for example, a Wi-Fi network or Bluetooth) that connects the navigation device 50 and the terminal device TM. The terminal device TM is realized, for example, by a portable communication terminal device such as a smartphone or a portable personal computer such as a tablet computer (tablet PC). The communication device 20 causes the storage 180 to store the schedule information 182 received from the terminal device TM. In this example, the communication device 20 is an example of the “schedule information acquirer.” In addition, the self-propelled parking controller 142 may activate the system of the own vehicle M through communication with the terminal device TM to start moving to the stop area 310a.

The self-propelled parking controller 142 generates a target trajectory up to the vicinity of the stop area 310a on the basis of the residential parking lot map information 184. When approaching the stop area 310a, the self-propelled parking controller 142 generates a target trajectory for causing the own vehicle M to be stopped in the stop area 310a according to a boarding mode based on the schedule information 182. After stopping the own vehicle M in the stop area 310a and letting the rider to board, the self-propelled parking controller 142 stops operating. Thereafter, manual driving or automated driving based on another functional unit is started.

In the present embodiment, self-propelled driving may be performed only at the time of vehicle storage or only at the time of vehicle retrieval.

The schedule information 182 includes, for example, irregular schedule information 182a indicating irregularly scheduled events (hereinafter referred to as irregular events) and regular schedule information 182b indicating regularly scheduled events (hereinafter referred to as regular events). The self-propelled parking controller 142 controls the own vehicle M in a different boarding mode depending on the type of an event that triggers the start of a self-propelled parking event relating to vehicle retrieval (hereinafter referred to as a vehicle retrieval trigger event) among the two types of events indicated in the schedule information 182. The self-propelled parking controller 142 controls the own vehicle M in a different exiting mode depending on the type of an event that has been performed until a self-propelled parking event relating to vehicle storage is started (hereinafter referred to as a vehicle storage trigger event) among the two types of events indicated in the schedule information 182. Hereinafter, details of each piece of the schedule information 182 and examples of boarding modes and exiting modes based on the two types of events will be described. In the following description, when boarding modes and exiting modes are not distinguished from each other, they will be referred to as boarding/exiting modes.

### About Irregular Events

FIG. 4 is a diagram showing an example of the content of the irregular schedule information 182a. The irregular schedule information 182a is information in which the date and time when an irregular event is to be performed, the content of the irregular event, the number of riders, a boarding place of the riders, and a destination are associated with each irregular event. An irregular event is, for example, an event that a rider schedules on a holiday. When an irregular event indicated in the irregular schedule information 182a is a vehicle retrieval trigger event or a vehicle storage trigger event, the self-propelled parking controller 142 starts, on the basis of the date and time associated with the irregular event, a self-propelled parking event at the corresponding time on the corresponding date. Then, the self-propelled parking controller 142 controls the boarding/exiting mode on the basis of some or all of the following.

(1) The number of riders is larger than a reference number of riders

(2) The amount of luggage is large or is assumed to be large

(3) Accommodation is involved

### (1) Irregular Event in which the Number of Riders is Larger than a Reference Number of Riders

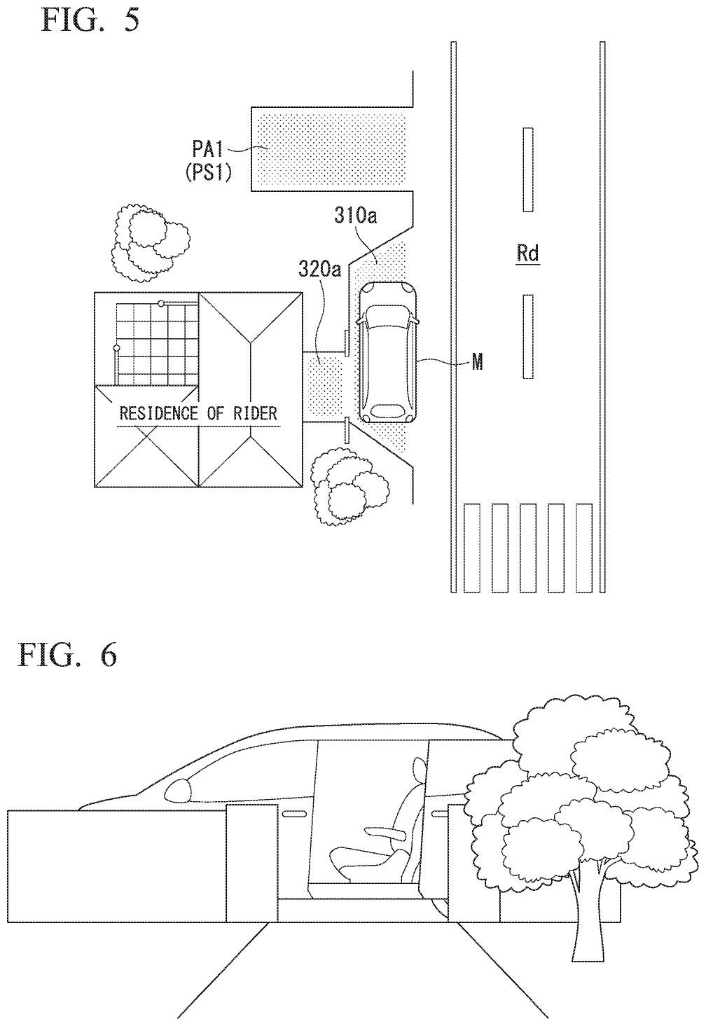

FIG. 5 is a diagram schematically showing a scene in which the own vehicle M is stopped in a boarding/exiting mode based on an irregular event in which the number of riders is larger than a reference number of riders. The self-propelled parking controller 142 causes the own vehicle M to be stopped in the stop area 310a at a stop position where riders can easily board or at a stop position where riders can easily exit, for example, when the vehicle retrieval trigger event or the vehicle storage trigger event is an irregular event and a larger number of riders than the reference number of riders is associated with the irregular event. The reference number of riders is, for example, the number of people who can board without using the rear seat (that is, the number of people who ride on the driver's seat and the passenger's seat (two in this case)). The stop position where riders can easily board and the stop position where riders can easily exit are, for example, stop modes of the own vehicle M in which the rear seat of the own vehicle M is close to the boarding/exiting area 320a. In this case, the self-propelled parking controller 142 generates a target trajectory on the basis of the residential parking lot map information 184 or a recognition result of the recognizer 130 such that a rear seat door of the own vehicle M approaches the position of the boarding/exiting area 320a. The self-propelled parking controller 142 causing the own vehicle M to be stopped at a stop position where riders can easily board is an example of “determining the boarding mode” and causing the own vehicle M to be stopped at a stop position where riders can easily exit is an example of “determining the exiting mode.”

FIG. 6 is a diagram schematically showing a scene after the own vehicle M is stopped on the basis of an irregular event in which the number of riders is large. For example, the self-propelled parking controller 142 provides a signal indicating that the own vehicle M has been stopped in the stop area 310a by a vehicle retrieval trigger event or a vehicle storage trigger event to a controller that controls opening and closing of doors of the own vehicle M (hereinafter referred to as a door controller). When the signal has been provided from the self-propelled parking controller 142, the door controller controls the rear seat door of the own vehicle M such that it is opened. Thereby, even when the number of riders of the own vehicle M is larger than the reference number of riders, the self-propelled parking controller 142 can let the riders smoothly board and exit.

### (2) Irregular Event in which the Amount of Luggage is Large or is Assumed to be Large

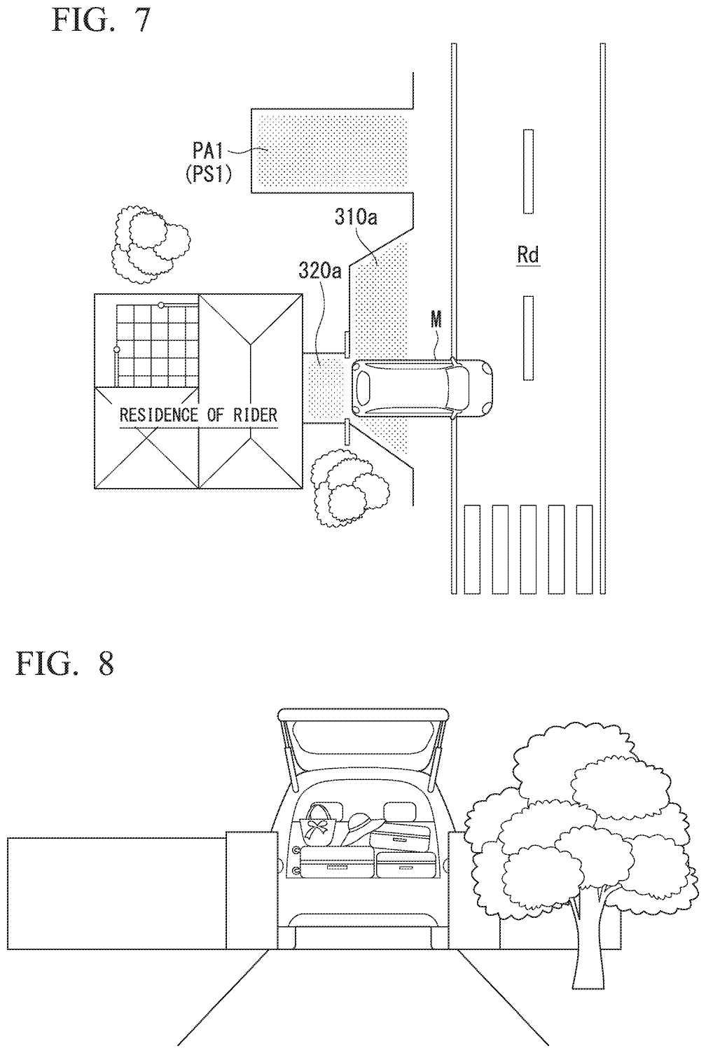

FIG. 7 is a diagram schematically showing a scene in which the own vehicle M is stopped in a boarding/exiting mode based on an irregular event in which the amount of luggage is large or is assumed to be large. The self-propelled parking controller 142 causes the own vehicle M to be stopped in the stop area 310a at a stop position where it is easy to load luggage or at a stop position where it is easy to unload luggage, for example, when the vehicle retrieval trigger event or the vehicle storage trigger event is an irregular event and the irregular event is an event in which the amount of luggage is large or is assumed to be large. The irregular event in which the amount of luggage is large or is assumed to be large is, for example, travel, shopping, or moving. An irregular event in which the amount of luggage is large or is assumed to be large may be determined in advance by the rider. Alternatively, the content of events in which the amount of luggage has been large among irregular events that have occurred so far may be learned by machine learning and whether or not the event is an event in which the amount of luggage is large or is assumed to be large may be determined on the basis of a learning model that has been learned. In this case, the automated driving control device 100 determines whether or not the amount of luggage has been large on the basis of an image captured by a vehicle interior camera (not shown) or a detection result of a sensor that detects the mass of luggage loaded in the trunk. The stop position where it is easy to load luggage or the stop position where it is easy to unload luggage is, for example, a stop mode of the own vehicle M in which the back door of the own vehicle M is close to the boarding/exiting area 320a. In this case, the self-propelled parking controller 142 generates a target trajectory on the basis of the residential parking lot map information 184 or a recognition result of the recognizer 130 such that the back door of the own vehicle M approaches the position of the boarding/exiting area 320a. The self-propelled parking controller 142 causing the own vehicle M to be stopped at a stop position where it is easy to load luggage is an example of “determining the boarding mode” and causing the own vehicle M to be stopped at a stop position where it is easy to unload luggage is an example of “determining the exiting mode.”

FIG. 8 is a diagram schematically showing a scene after the own vehicle M is stopped on the basis of an irregular event in which the amount of luggage is large or is assumed to be large. For example, the self-propelled parking controller 142 provides a signal indicating that the own vehicle M has been stopped in the stop area 310a by a vehicle retrieval trigger event or a vehicle storage trigger event to the door controller. When the signal has been provided from the self-propelled parking controller 142, the door controller controls the back door of the own vehicle M such that it is opened. The self-propelled parking controller 142 may generate a target trajectory for stopping the own vehicle M while securing a separation distance from the boarding/exiting area 320a such that the back door can be opened. Thereby, the self-propelled parking controller 142 can allow the rider to smoothly load and unload luggage even when the amount of luggage is large or is assumed to be large.

### (3) Irregular Event in which Accommodation is Involved

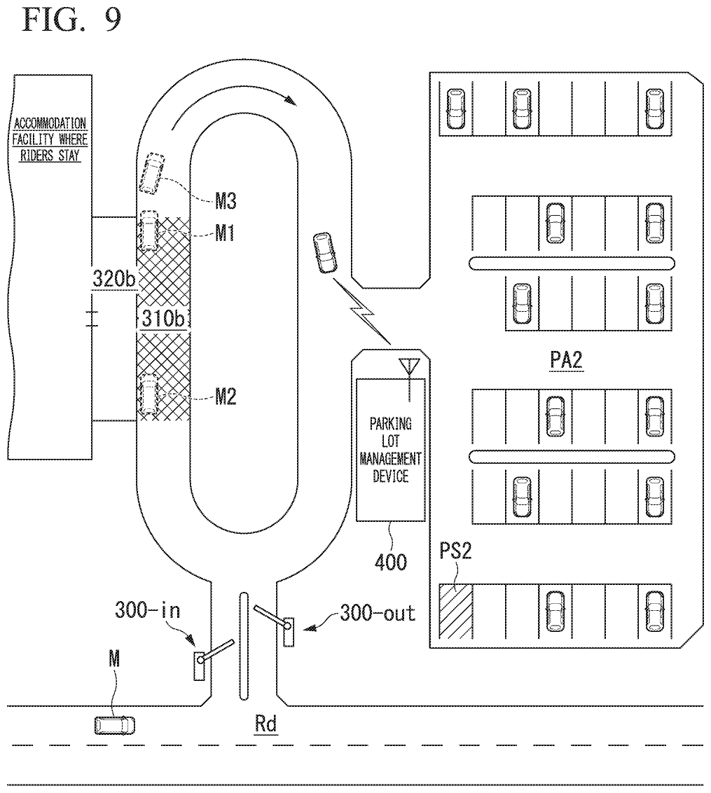

FIG. 9 is a diagram schematically showing a scene in which the own vehicle M is stopped in a boarding/exiting mode based on an irregular event in which accommodation is involved. For example, when the vehicle retrieval trigger event or the vehicle storage trigger event is an irregular event and the irregular event is an event in which accommodation is involved such as a trip, the self-propelled parking controller 142 causes the own vehicle M to be stopped in or near a stop area 310b of an accommodation facility where riders stay at a stop position where riders can easily board, a stop position where riders can easily exit, a stop position where it is easy to load luggage, or a stop position where it is easy to unload luggage among positions in or near the stop area 310b at which the own vehicle M does not interfere with other users of the accommodation facility. A parking lot PA2 of the accommodation facility is, for example, a non-valet parking lot. Hereinafter, a self-propelled parking event when the own vehicle M is stored in and retrieved from a non-valet parking lot will be described.

### Self-Propelled Parking Event—at the Time of Vehicle Storage

Gates 300-in and 300-out are provided on a route from a road Rd to an accommodation facility where riders stay and a route from the accommodation facility to the road Rd, respectively. The own vehicle M advances to the vicinity of the stop area 310b through the gate 300-in by manual driving or automated driving. The stop area 310 faces a boarding/exiting area 320b connected to the accommodation facility. An eave for blocking rain and snow is provided in the boarding/exiting area 320b.

After causing the own vehicle M to move to the vicinity of the stop area 310b, the self-propelled parking controller 142 causes the own vehicle M to be stopped in or near the stop area 310b at a stop position where riders easily exit or at a stop position where it is easy to unload luggage among positions where the own vehicle M does not interfere with other users of the accommodation facility. The stop position where riders can easily exit or the stop position where it is easy to unload luggage is, for example, a stop mode of the own vehicle M in which the own vehicle M is caused to be stopped at an end of the stop area 310b (at the position of an own vehicle M1 or M2 shown in FIG. 9) or at a position near the stop area 310b but outside the stop area 310b (at the position of an own vehicle M3 shown). In this case, the self-propelled parking controller 142 recognizes the position of the boarding/exiting area 320b on the basis of a recognition result of the recognizer 130 and generates a target trajectory of the own vehicle M.

After letting the rider exit in the stop area 310b, the own vehicle M starts a self-propelled parking event of performing automated driving to move to a parking space PS2 in the parking lot PA2. A start trigger of the self-propelled parking event may be, for example, an operation performed by a rider or may be reception of a predetermined signal wirelessly from the parking lot management device 400. Upon starting the self-propelled parking event, the self-propelled parking controller 142 transmits a parking request to the parking lot management device 400 by controlling the communication device 20. Then, the own vehicle M moves from the stop area 310b to the parking lot PA2 while following guidance of the parking lot management device 400 or performing sensing by itself.

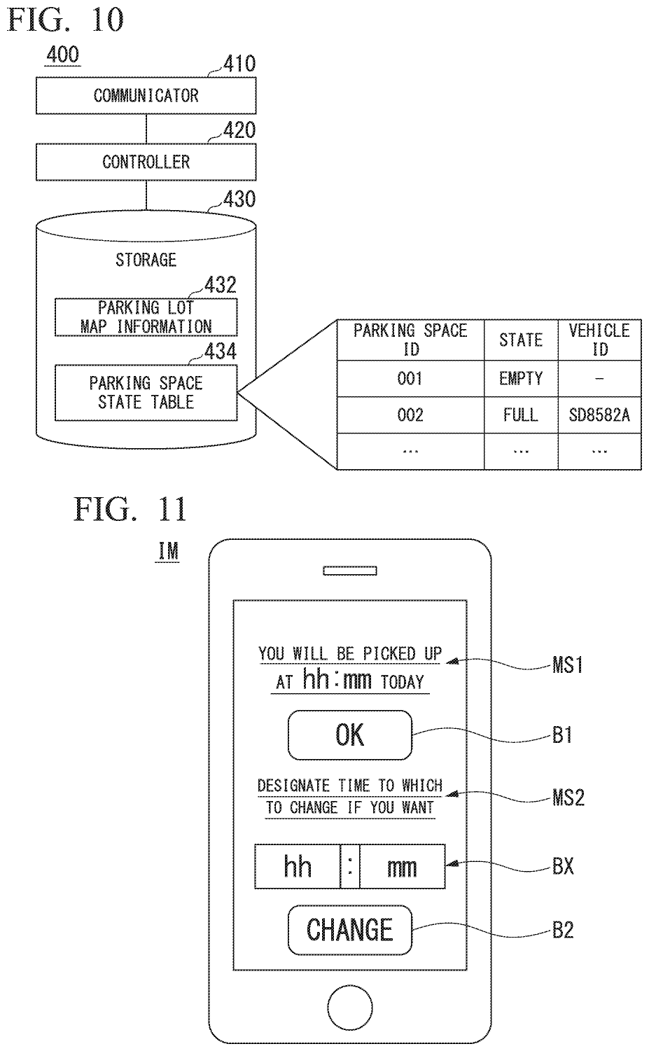

FIG. 10 is a diagram showing an example of the configuration of the parking lot management device 400. The parking lot management device 400 includes, for example, a communicator 410, a controller 420, and a storage 430. The storage 430 stores information such as parking lot map information 432 and a parking space state table 434.

The communicator 410 wirelessly communicates with the own vehicle M and other vehicles. The controller 420 guides the vehicle to the parking space PS2 on the basis of the information acquired by the communicator 410 and the information stored in storage 430. The parking lot map information 432 is information geometrically representing the structure of the parking lot PA2. The parking lot map information 432 includes coordinates of each parking space PS2. The parking space state table 434 is, for example, a table in which a state indicating whether a parking space is empty or full (occupied) and a vehicle ID that is identification information of a vehicle parked in the parking space if the parking space is full are associated with each parking space ID that is identification information of the parking space PS2.

When the communicator 410 has received a parking request from a vehicle, the controller 420 refers to the parking space state table 434 to extract an empty parking space PS2, acquires the position of the extracted parking space PS2 from the parking lot map information 432, and transmits a suitable route to the acquired position of the parking space PS2 to the vehicle using the communicator 410. Based on the positional relationships of a plurality of vehicles, the controller 420 instructs a specific vehicle to stop, slow down or the like as necessary such that vehicles do not proceed to the same position at the same time.

In the vehicle that has received the route (hereinafter assumed to be an own vehicle M), the self-propelled parking controller 142 generates a target trajectory based on the route. When approaching the target parking space PS2, the parking space recognizer 132 recognizes a parking frame line or the like defining the parking space PS2 to recognize a detailed position of the parking space PS2 and provides the recognized detailed position of the parking space PS2 to the self-propelled parking controller 142. Upon receiving this, the self-propelled parking controller 142 corrects the target trajectory and causes the own vehicle M to be parked in the parking space PS2.

### Self-Propelled Parking Event—at the Time of Vehicle Retrieval

The self-propelled parking controller 142 and the communication device 20 remain in operation while the own vehicle M is parked. The self-propelled parking controller 142 activates the system of the own vehicle M to move the own vehicle M to the vicinity of the stop area 310b, for example, when the vehicle storage trigger event is an irregular event and the irregular event is an event in which accommodation is involved such as a trip. At this time, the self-propelled parking controller 142 transmits a start request to the parking lot management device 400 by controlling the communication device 20. Based on the positional relationships of a plurality of vehicles, the controller 420 of the parking lot management device 400 instructs a specific vehicle to stop, slow down or the like as necessary such that vehicles do not proceed to the same position at the same time, similar to the case of vehicle storage. After causing the own vehicle M to move to the vicinity of the stop area 310b, the self-propelled parking controller 142 causes the own vehicle M to be stopped in or near the stop area 310b at a stop position where riders easily board or at a stop position where it is easy to load luggage among positions where the own vehicle M does not interfere with other users of the accommodation facility. The stop position where riders easily board and the stop position where it is easy to load luggage are the same as the stop position where riders can easily exit and the stop position where it is easy to unload luggage in the stop area 310b described above and therefore description thereof is omitted here. When the own vehicle M is caused to move to the stop area 310b and the riders board the own vehicle M, the self-propelled parking controller 142 stops operating. Thereafter, manual driving or automated driving based on another functional unit is started.

The self-propelled parking controller 142 is not limited to the above description but may find an empty parking space by itself on the basis of detection results of the camera 10, the radar device 12, the finder 14, or the object recognition device 16 without depending on communication and cause the own vehicle M to be parked in the found parking space.

### Notification of Irregular Event

Here, a rider may perform an irregular event at a time later than the scheduled time. In this case, if the self-propelled parking controller 142 starts a self-propelled parking event at the time of the date associated with the irregular event, the own vehicle M is left in the stop area 310a or 310b for a long time and thus may interfere with other vehicles. To prevent this, the self-propelled parking controller 142 causes information notifying that the irregular event is scheduled (hereinafter referred to as notification information) to be transmitted to the terminal device TM possessed by the rider through the communication device 20 at a time slightly before the time of the date associated with the irregular event.

FIG. 11 is a diagram showing an example of an execution screen IM of a notification application executed in the terminal device TM. The notification application is an application for receiving a change in schedule while presenting the content of the notification information acquired from the automated driving control device 100 to the rider. When the notification application has been activated, an interface screen is displayed on a display screen of the terminal device TM. A message MS1 indicating the time at which the irregular event is scheduled is presented on the interface screen, and a button B1 for permitting the start of a self-propelled parking event, for which the irregular event is used as a vehicle storage trigger or a vehicle retrieval trigger, at the scheduled time of the irregular event is provided on the interface screen. In addition, a message MS2 prompting the user to input a time to which to change the time of the irregular event when he or she desires to change the time of the irregular event is presented on the interface screen and a comment box BX for inputting the time to which to change the time of the irregular event and a button B2 for executing the change of the time of the irregular event is provided on the interface screen. The notification application terminates the process when an operation of selecting the button B1 has been performed on the interface screen and transmits information indicating the changed time of the irregular event input into the comment box BX to the automated driving control device 100 when an operation of selecting the button B2 has been performed. Upon receiving the information indicating the changed time of the irregular event through the communication device 20, the self-propelled parking controller 142 updates the irregular schedule information 182a on the basis of the received information.

### About Regular Events

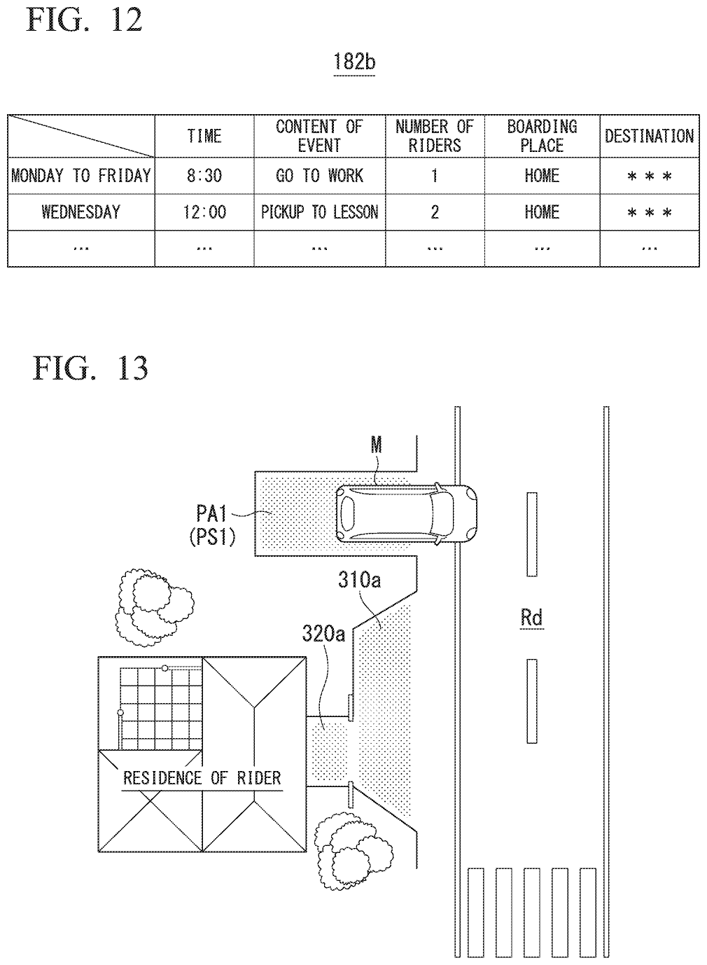

FIG. 12 is a diagram showing an example of the content of the regular schedule information 182b. The regular schedule information 182b is information in which the date and time when a regular event is to be performed, the content of the regular event, the number of riders, a boarding place of the riders, and a destination are associated with each regular event. A regular event is, for example, an event that a rider schedules routinely every week (or every day). When a regular event indicated in the regular schedule information 182b is a vehicle retrieval trigger event or a vehicle storage trigger event, the self-propelled parking controller 142 starts, on the basis of the date and time associated with the regular event, a self-propelled parking event at a time slightly before (for example, 5 minutes before) the corresponding time on the corresponding date.

### Boarding/Exiting Mode of Regular Event

FIG. 13 is a diagram schematically showing a scene in which the own vehicle M is stopped in a boarding/exiting mode based on a regular event in which the number of riders is large. For example, when a vehicle retrieval trigger event is a regular event, the self-propelled parking controller 142 causes the own vehicle M to be stopped in a boarding mode in which vehicle retrieval is easy.

The boarding mode in which vehicle retrieval is easy is, for example, a stop mode of the own vehicle M in which a short time is required until the own vehicle M departs after riders leave the residence. In the example shown in FIG. 13, the self-propelled parking controller 142 generates a target trajectory for causing the own vehicle M to be headed out of the parking lot PA1 to the extent that the door of the driver's seat exits the parking lot PA1 on the basis of a recognition result of the recognizer 130. In this case, the self-propelled parking controller 142 does not perform the processing relating to movement to the stop area 310a as performed at the time of vehicle retrieval from the parking lot PA1 in an irregular event. The self-propelled parking controller 142 may cause the own vehicle M to be stopped in the stop area 310a when the residence of riders, the stop area 310a, and the parking lot PA1 have a positional relationship according to which retrieval of the own vehicle M into the stop area 310a can shorten the time required until the own vehicle M departs. In this case, the self-propelled parking controller 142 performs the processing relating to movement to the stop area 310a as performed at the time of vehicle retrieval from the parking lot PA1 in an irregular event. At this time, the self-propelled parking controller 142 may generate, for example, a target trajectory such that the travel direction of the own vehicle M is toward the destination relating to the regular event.

The above description refers to the case where the irregular event is a holiday event, but the present invention is not limited thereto. If there is a regular event on a weekly holiday, it may be added to (registered in) the regular schedule information 182b as a regular event although it is a holiday event.

### Control of Headlights 70 Based on Annual Event

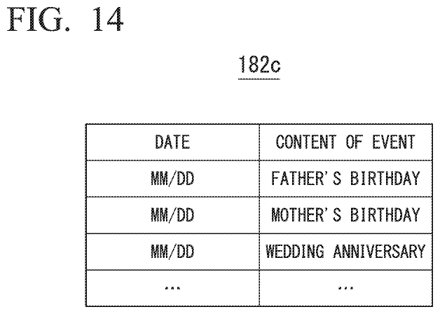

In the above description, control for determining the boarding/exiting mode on the basis of the schedule information 182 has been described. Hereinafter, control for determining the lighting mode of the headlights 70 on the basis of the schedule information 182 will be described. The schedule information 182 further includes, for example, annual schedule information 182c. FIG. 14 is a diagram showing an example of the content of the annual schedule information 182c. The annual schedule information 182c is information in which the date when an annual event is performed and the content of the annual event are associated with each annual event. An annual event is, for example, an event that a rider schedules routinely every year. In this example, it is assumed that the annual event is a celebration such as a birthday or an anniversary. The illumination controller 170 determines whether or not the current date is the date of the annual event on the basis of the annual schedule information 182c. When the current date is the date of the annual event, the illumination controller 170 causes the headlights 70 to be lit while the self-propelled parking event is being performed by the self-propelled parking controller 142. At this time, the illumination controller 170 causes the headlights 70 to be lit in a different mode from a mode in which the headlights 70 are lit normally (that is, a lighting mode intended to emit light in front of the own vehicle M). The different lighting mode is, for example, a lighting mode in which the headlights 70 blink or the left and right headlights 70 are alternately lit (hereinafter referred to as a first lighting mode). Thereby, the illumination controller 170 can entertain riders when they board the own vehicle M on the day of a celebration.

During execution of a self-propelled parking event for which an irregular event or a regular event is used as a vehicle retrieval trigger event or a vehicle storage trigger event, the illumination controller 170 may cause the headlights 70 to be lit in a lighting mode that corresponds to each event and is different from the normal lighting mode. Since the irregular event may be, for example, an event that the riders are looking forward to on a holiday, the illumination controller 170 causes the headlights 70 to be lit in a lighting mode to entertain the riders (for example, a mode of slow blinking (hereinafter referred to as a second lighting mode)). Since the regular event may be, for example, an event for which the time is strictly set in advance, the illumination controller 170 may cause the headlights 70 to be lit in a lighting mode to prompt riders to board (for example, a mode of fast blinking (hereinafter referred to as a third lighting mode)).

The lighting mode corresponding to each event may be determined by the user or automatically. The lighting mode corresponding to each event may be determined by learning lighting modes that the user instructed on the day of the event by machine learning and may then be executed on the basis of a learning model that has been learned.

### Operation Flow Relating to Irregular Event

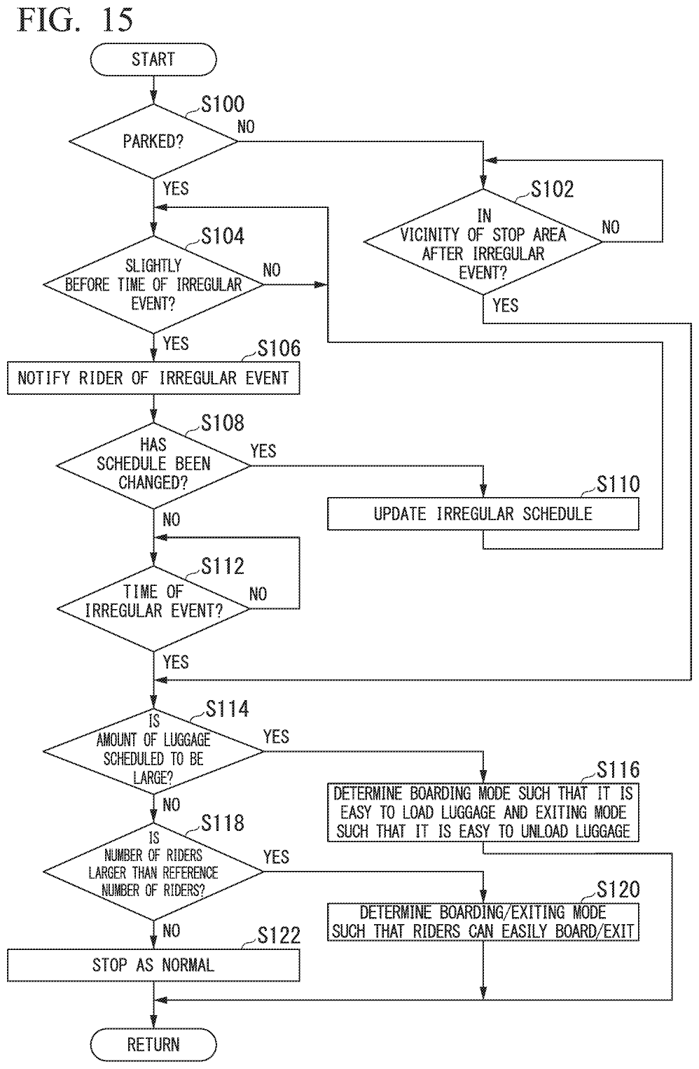

FIG. 15 is a flowchart showing a flow of a series of processing for determining a boarding/exiting mode based on an irregular event. First, the self-propelled parking controller 142 determines whether or not the own vehicle M is parked in the parking lot PA1 or PA2 (step S100). Upon determining that the own vehicle M is not parked in the parking lot PA1 or PA2, the self-propelled parking controller 142 waits until the position of the own vehicle M is in the vicinity of the stop area 310a or 310b (that is, until a condition relating to vehicle storage of a self-propelled parking event is satisfied) after traveling of the own vehicle M according to an irregular event (a vehicle storage trigger event) (step S102).

Upon determining that the own vehicle M is parked in the parking lot PA1 or PA2, the self-propelled parking controller 142 determines whether or not the current time is slightly (for example, 10 minutes) before the time associated with the irregular event indicated in the irregular schedule information 182a (step S104). Upon determining that the current time is slightly before the time associated with the irregular event, the self-propelled parking controller 142 causes notification information notifying that the irregular event is scheduled to be transmitted to the terminal device TM through the communication device 20 (step S106). The self-propelled parking controller 142 determines whether or not information indicating change of the time of the irregular event and the changed time has been received through the communication device 20 (step S108). Upon determining that the information indicating change of the time of the irregular event has been received through the communication device 20, the self-propelled parking controller 142 updates the irregular schedule information 182a on the basis of the received information (step S110). The self-propelled parking controller 142 repeats the processing of steps S104 to S110 until the time of the irregular event is determined. Upon determining that no change has been made to the irregular event, the self-propelled parking controller 142 waits until the time of the irregular event (the vehicle retrieval trigger event) (that is, until a condition relating to vehicle retrieval of a self-propelled parking event is satisfied) (step S112).

The self-propelled parking controller 142 starts processing relating to determination of a boarding/exiting mode based on the irregular event when a condition relating to vehicle storage/retrieval of a self-propelled parking event is satisfied. Accordingly, the self-propelled parking controller 142 moves the own vehicle M to the vicinity of the stop area 310a or 310b. The self-propelled parking controller 142 determines whether or not the irregular event that is a vehicle storage trigger event or a vehicle retrieval trigger event is an irregular event in which the amount of luggage is large or is assumed to be large (step S114). Upon determining that the irregular event is an irregular event in which the amount of luggage is large or is assumed to be large, the self-propelled parking controller 142 determines that the boarding/exiting mode is a stop position where it is easy to load luggage or a stop position where it is easy to unload luggage and generates a target trajectory of the own vehicle M for realizing the determined boarding/exiting mode (step S116). Upon determining that the irregular event is not an irregular event in which the amount of luggage is large or is assumed to be large, the self-propelled parking controller 142 determines whether or not the irregular event is an irregular event in which the number of riders is larger than a reference number of riders (step S118). Upon determining that the irregular event is an irregular event in which the number of riders is larger than the reference number of riders, the self-propelled parking controller 142 determines that the boarding/exiting mode is a boarding/exiting mode in which riders can easily board/exit and generates a target trajectory of the own vehicle M for realizing the determined boarding/exiting mode (step S120). Upon determining that the irregular event is an irregular event in which the number of riders is equal to or smaller than the reference number of riders, the self-propelled parking controller 142 causes the own vehicle M to be stopped in a normal stop mode (step S122).

The above description refers to the case where determination of a boarding/exiting mode according to an irregular event in which the amount of luggage is large or is assumed to be large is given priority over determination of a boarding/exiting mode according to an irregular event in which the number of riders is larger than the reference number of riders when the irregular event satisfies both that the amount of luggage is large or is assumed to be large and that the number of riders is larger than the reference number of riders. However, the present invention is not limited to this. Determination of a boarding/exiting mode according to an irregular event in which the number of riders is larger than the reference number of riders may be given priority over determination of a boarding/exiting mode according to an irregular event in which the amount of luggage is large or is assumed to be large or the user may predetermine an irregular event which is given priority.

### Operation Flow Relating to Regular Event

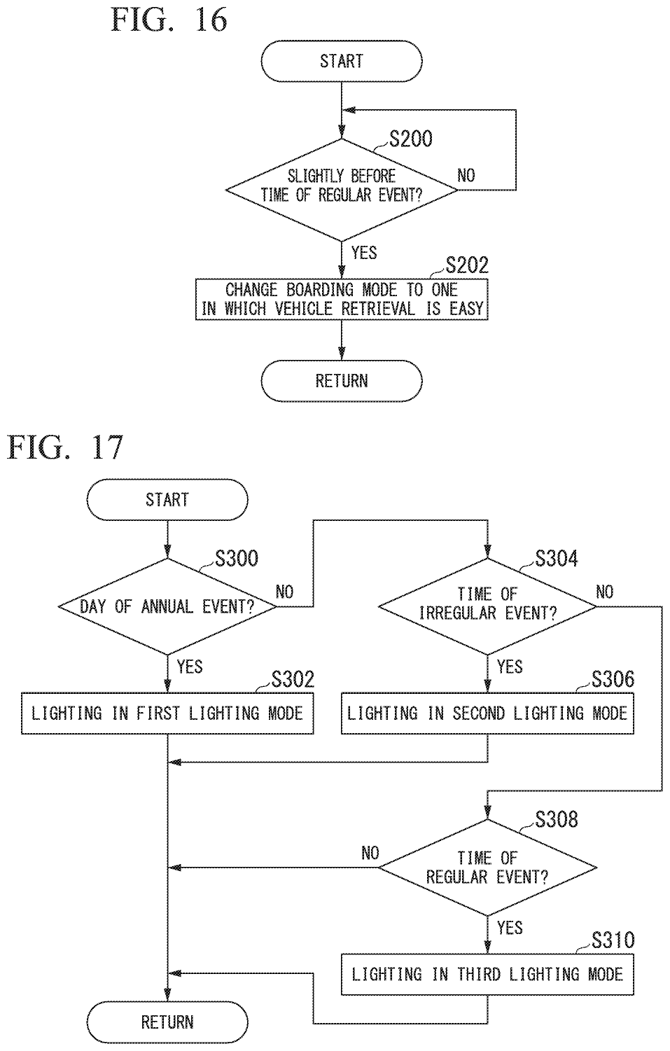

FIG. 16 is a flowchart showing a flow of a series of processing for determining a boarding mode based on a regular event. First, based on the regular schedule information 182b, the self-propelled parking controller 142 waits until the current time is slightly (for example, 5 minutes) before the time associated with the regular event indicated in the regular schedule information 182b (step S200). When the current time is slightly before the time associated with the regular event, the self-propelled parking controller 142 determines that the boarding mode is a boarding mode in which vehicle retrieval is easy and generates a target trajectory of the own vehicle M for realizing the determined boarding mode (step S202).

### Control of Lighting Mode of Headlights 70 Based on Event

FIG. 17 is a flowchart showing a series of flow of processing for determining a lighting mode of the headlights 70 based on an event. First, the illumination controller 170 determines whether or not the current date is a date when an annual event indicated in the annual schedule information 182c is scheduled (step S300). Upon determining that the current date is the date of an annual event, the illumination controller 170 causes the headlights 70 to be lit in a first lighting mode corresponding to the annual event at the timing when a self-propelled parking event is performed (step S302). Upon determining that the current date is not the date of the annual event, the illumination controller 170 determines whether the current date and time is the date and time when an irregular event indicated in the irregular schedule information 182a is scheduled (step S304). Upon determining that the current date and time is the date and time of the irregular event, the illumination controller 170 causes the headlights 70 to be lit in a second lighting mode corresponding to the irregular event at the timing when a self-propelled parking event is performed (step S306). Upon determining that the current date and time is not the date and time of the irregular event, the illumination controller 170 determines whether or not the current date and time is the date and time when a regular event indicated in the regular schedule information 182b is scheduled (step S308). Upon determining that the current date and time is the date and time of the regular event, the illumination controller 170 causes the headlights 70 to be lit in a third lighting mode corresponding to the regular event at the timing when a self-propelled parking event is performed (step S310). The illumination controller 170 terminates the process upon determining that there is no event scheduled for the current date and time.

### Method of Acquiring Schedule Information 182

The above description refers to the case where the schedule information 182 is provided from the terminal device TM possessed by the rider of the own vehicle M to the vehicle system 1 via the network or is provided to the vehicle system 1 via short-range wireless communication that connects the navigation device 50 and the terminal device TM. However, the present invention is not limited to this. The communication device 20 may acquire schedule information 182 of the rider, for example, from a server device in which the schedule information 182 of the rider is stored. The schedule information 182 may indicate at least one of a working day and a holiday based on a work system of the rider. In this case, the self-propelled parking controller 142 may recognize the working day and the holiday of the rider on the basis of the schedule information 182 and control a boarding mode or an exiting mode according to a regular event relating to the working day or the holiday.

### Summary of Embodiment

As described above, the automated driving control device 100 according to the present embodiment includes the recognizer 130 that recognizes a surrounding environment of the own vehicle M, a driving controller (the behavior plan generator 140 and the second controller 160 in this example) that performs at least one of speed control and steering control of the own vehicle M on the basis of the recognition result of the recognizer 130, a schedule information acquirer (the communication device 20 in this example) that acquires schedule information of the rider of the own vehicle M (the schedule information 182 in this example), wherein the driving controller determines an exiting mode for the own vehicle M letting the rider exit or a boarding mode for the own vehicle M letting the rider board on the basis of the schedule information 182, whereby it is possible to cause the own vehicle M to be stopped such that the rider can easily board and exit according to the state of the rider.

### Hardware Configuration

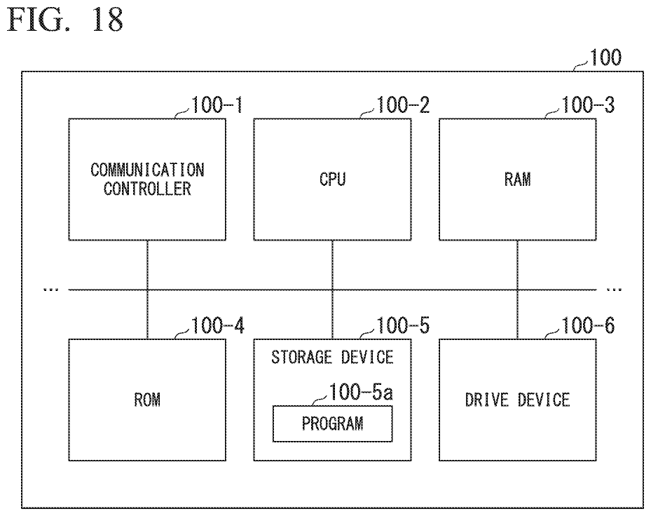

FIG. 18 is a diagram showing an example of the hardware configuration of the automated driving control device 100 according to an embodiment. As shown, the automated driving control device 100 is configured such that a communication controller 100-1, a CPU 100-2, a random access memory (RAM) 100-3 used as a working memory, a read only memory (ROM) 100-4 storing a boot program or the like, a storage device 100-5 such as a flash memory or a hard disk drive (HDD), a drive device 100-6, or the like are connected to each other via an internal bus or a dedicated communication line. The communication controller 100-1 performs communication with components other than the automated driving control device 100. The storage device 100-5 stores a program 100-5a to be executed by the CPU 100-2. This program is loaded in the RAM 100-3 by a direct memory access (DMA) controller (not shown) or the like and then executed by the CPU 100-2. Thereby, some or all of the parking space recognizer 132, the behavior plan generator 140, and the self-propelled parking controller 142 are realized.

The embodiments described above can also be expressed as follows.

An automated control system including: a storage device configured to store a program; and a hardware processor, wherein the hardware processor is configured to execute the program stored in the storage device to: recognize a surrounding environment of a vehicle; perform at least one of speed control and steering control of the vehicle on the basis of a result of the recognition; acquire schedule information of a rider of the vehicle; and determine an exiting mode for the vehicle letting the rider exit or a boarding mode for the vehicle letting the rider board on the basis of the acquired schedule information.

Although the modes for carrying out the present invention have been described above by way of embodiments, the present invention is not limited to these embodiments at all and various modifications and substitutions can be made without departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle;
a driving controller configured to perform at least one of speed control and steering control of the vehicle on the basis of a recognition result of the recognizer; and
a schedule information acquirer configured to acquire schedule information of a rider of the vehicle,
wherein the driving controller is configured to determine an exiting mode for the vehicle letting the rider exit or a boarding mode for the vehicle letting the rider board on the basis of the schedule information acquired by the schedule information acquirer.

2. The vehicle control system according to claim 1, wherein the schedule information includes an irregular event that is scheduled irregularly, and
the driving controller is configured to determine a stop position of the vehicle on the basis of information associated with the irregular event when the irregular event has been scheduled.

3. The vehicle control system according to claim 2, further comprising an inquirer configured to inquire, at a time that is a predetermined duration before a pick-up time associated with the irregular event, of the rider whether or not pick-up at the pick-up time is possible and to acquire an inquiry result,
wherein the driving controller is configured to control the vehicle on the basis of the inquiry result acquired by the inquirer.

4. The vehicle control system according to claim 1, wherein the schedule information includes a regular event that is scheduled regularly,
wherein the driving controller is configured to determine the boarding mode such that a short amount of time is required until the vehicle departs.

5. The vehicle control system according to claim 4, wherein the driving controller is configured to determine the boarding mode such that the rider can board at a pick-up time associated with the regular event even if there is no instruction from the rider.

6. The vehicle control system according to claim 1, wherein the schedule information includes the number of riders,
wherein the driving controller is configured to, when the number of riders is larger than a reference, change the boarding mode to a stop position where the riders can easily board compared to when the number of riders is equal to or smaller than the reference and to determine that the exiting mode is a stop position where the riders can easily exit.

7. The vehicle control system according to claim 1, wherein the schedule information includes an accommodation place where the rider stays after exiting the vehicle,
wherein the driving controller is configured to, when a pick-up position of the vehicle is a position of the accommodation place, change the boarding mode to a stop position where the rider can easily board or a stop position where the rider can easily load luggage in the vehicle, and determine that the exiting mode is a stop position where the rider can easily exit or a stop position where the rider can easily unload luggage from the vehicle.

8. The vehicle control system according to claim 1, wherein the schedule information includes a predetermined day regarding the rider or a predetermined schedule regarding the rider, and
the vehicle control system further comprises an illumination controller configured to control an illumination provided in the vehicle,
wherein the illumination controller is configured to determine a lighting mode of the illumination when a current day corresponds to the predetermined day or a day of the predetermined schedule.

9. The vehicle control system according to claim 8, wherein the schedule information includes a regular event that is scheduled regularly or an irregular event that is scheduled irregularly,
wherein the illumination controller is configured to make the lighting mode of the illumination different when the driving controller performs control relating to the regular event and when the driving controller performs control relating to the irregular event.

10. The vehicle control system according to claim 1, wherein the schedule information includes at least one of the number of riders scheduled to board the vehicle, an attribute of the riders of the vehicle, and a destination of the vehicle,
wherein the driving controller is configured to change a boarding mode and an exiting mode on the basis of the number of riders scheduled to board the vehicle, the attribute of the riders of the vehicle, or the destination of the vehicle.

11. A vehicle control method comprising:
a computer recognizing a surrounding environment of a vehicle;
performing at least one of speed control and steering control of the vehicle on the basis of a result of the recognition;
acquiring schedule information of a rider of the vehicle; and
determining an exiting mode for the vehicle letting the rider exit or a boarding mode for the vehicle letting the rider board on the basis of the acquired schedule information.

12. A non-transitory computer-readable storage medium storing a program that causes a computer to:
recognize a surrounding environment of a vehicle;
perform at least one of speed control and steering control of the vehicle on the basis of a result of the recognition;
acquire schedule information of a rider of the vehicle; and
determine an exiting mode for the vehicle letting the rider exit or a boarding mode for the vehicle letting the rider board on the basis of the acquired schedule information.
